(19) United States
(12) Patent Application Publication
(10) Pub. No.: US 2006/0072924 A1
(43) Pub. Date: Apr. 6, 2006

(54) Duo-binary optical transmitter tolerant to chromatic dispersion

(75) Inventors: Jae-Hoon Lee, Seoul (KR); Byung-Jik Kim, Seongnam-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/216,761

(22) Filed: Aug. 31, 2005

(30) Foreign Application Priority Data
Oct. 4, 2004 (KR) 2004-78766

(51) Int. Cl. H04B 10/04

(52) U.S. Cl. 398/183

(57) ABSTRACT

A duo-binary optical transmitter tolerant to a chromatic dispersion includes a pre-coder for generating a first 2-level signal from input binary data and generating a second signal having a waveform obtained by inverting the first signal, a Mach-Zehnder Modulator (MZM) for generating a Differential Phase Shift Keying (DPSK) modulated optical signal by modulating an input light according to the first signal and the second signal, and a Delay Interferometer (DI) for splitting the DPSK modulated optical signal into a first split signal and a second split signal, delaying the second split signal, and generating a duo-binary optical signal by interfering the first split signal with the second delayed split signal, wherein a time required for delaying the second split signal is set to 0.5˜0.8 bit.

### CLAIM OF PRIORITY

This application claims priority to an application entitled “Duo-binary Optical Transmitter tolerant to Chromatic Dispersion,” filed in the Korean Intellectual Property Office on Oct. 4, 2004 and assigned Serial No. 2004-78766, the contents of which are incorporated herein by reference.

### BACKGROUND OF THE INVENTION

1. Field of the Invention

The present invention relates to an optical transmitter, and more particularly to a duo-binary optical transmitter for outputting duo-binary optical signals by means of a Mach-Zehnder Modulator (MZM) and a Delay Interferometer (DI).

2. Description of the Related Art

Modulation schemes of an optical communication system have been developed to increase the transmission speed and transmission efficiency. An existing On-Off Keying (OOK) modulation scheme has disadvantages in that it has a wide spectrum of an optical signal, thus easily influenced by a chromatic dispersion of an optical fiber. In contrast, a duo-binary modulation scheme has advantages in that it has a narrow spectrum of an optical signal and thereby less influenced by the chromatic dispersion of an optical fiber.

FIG. 1 is a block diagram showing a conventional duo-binary optical transmitter. As shown, the optical transmitter includes a Pulse Pattern Generator (PPG) 110, a pre-coder 120, a first and a second Low Pass Filter (LPF) 130 and 140, a first and a second amplifier (AMP) 150 and 160, a Light Source (LS) 170, and an MZM 180.

In operation, the PPG 110 outputs binary data 112 and the pre-coder 120 outputs a first signal 122, which is obtained by pre-coding the binary data 112 into a 2-level signal, and a second signal 124 having a waveform inverse corresponding to the first signal 122. The first LPF 130 outputs a third signal 132 obtained by converting the first signal 122 into a 3-level signal, and the second LPF 140 outputs a fourth signal 142 obtained by converting the second signal 124 into a 3-level signal. The first AMP 150 amplifies and outputs the third signal 132, and the second AMP 160 amplifies and outputs the fourth signal 142. The LS 170 is a Distributed FeedBack (DFB) laser and outputs a light 172 having a predetermined wavelength. The MZM 180 modulates the light input from the LS 170 according to the amplified third signal 152 and fourth signal 162, then output a 2-level duo-binary optical signal 182.

Since the conventional optical transmitter uses the 3-level third signal and fourth signal, the 2-level duo-binary optical signal output from the MZM may be deteriorated due to a non-linearity of the first and the second AMP. In order to solve this problem, a method has been proposed, in which a 2-level duo-binary optical signal is generated by applying a 2-level signal to the MZM. According to this method, an optical transmitter generates a Differential Phase Shift Keying (DPSK) modulated optical signal by applying 2-level signals output from a pre-coder to an MZM, and then generates a 2-level duo-binary optical signal by inputting the generated optical signal into a 1-bit DI. However, this method is much less tolerant to the chromatic dispersion of an optical fiber.

### SUMMARY OF THE INVENTION

Accordingly, the present invention has been made to solve the above-mentioned problems occurring in the prior art and provides additional advantages, by providing a duo-binary optical transmitter tolerant to chromatic dispersion of an optical fiber.

In one embodiment, there is provided a duo-binary optical transmitter tolerant to a chromatic dispersion, the duo-binary optical transmitter including: a pre-coder for generating a first 2-level signal from input binary data and for generating a second signal having a waveform obtained by inverting the first signal; a Mach-Zehnder Modulator (MZM) for generating a Differential Phase Shift Keying (DPSK) modulated optical signal by modulating an input light according to the first signal and the second signal; and a Delay Interferometer (DI) for splitting the DPSK modulated optical signal into a first split signal and a second split signal, delaying the second split signal, and generating a duo-binary optical signal by interfering the first split signal with the second delayed split signal, wherein the time required for delaying the second split signal is set to 0.5˜0.8 bit.

### BRIEF DESCRIPTION OF THE DRAWINGS

The above features and advantages of the present invention will be more apparent from the following detailed description taken in conjunction with the accompanying drawings, in which:

FIG. 1 is a block diagram showing a conventional duo-binary optical transmitter;

FIG. 2 is a block diagram showing a duo-binary optical transmitter according to an embodiment of the present invention;

FIG. 3 is an eye diagram showing a back-to-back monitoring result for a duo-binary optical signal obtained by setting the delay time of the optical transmitter shown in FIG. 2 to 0.8 bit;

FIG. 4 is an eye diagram showing a monitoring result for a duo-binary optical signal after the duo-binary optical signal obtained by setting the delay time of the optical transmitter shown in FIG. 2 to 0.8 bit has been transmitted 160 km;

FIG. 5 is an eye diagram showing a back-to-back monitoring result for a duo-binary optical signal obtained by setting the delay time of the optical transmitter shown in FIG. 2 to 1 bit;

FIG. 6 is an eye diagram showing a monitoring result for a duo-binary optical signal after the duo-binary optical signal obtained by setting the delay time of the optical transmitter shown in FIG. 2 to 1 bit has been transmitted 160 km;

FIG. 7 is a graph illustrating the change of a receiver sensitivity according to the delay time of the optical transmitter shown in FIG. 2;

FIG. 8 is a graph showing a comparison of the optical transmitter shown in FIG. 2 having a delay time of 0.7 T and the optical transmitter having a delay time of 1.0 T; and

FIG. 9 is a graph showing an optimal delay time range of the optical transmitter shown in FIG. 2.

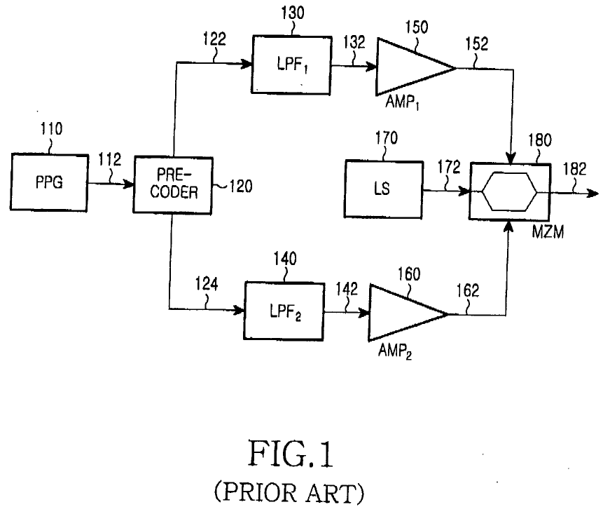

### DETAILED DESCRIPTION

Hereinafter, embodiments according to the present invention will be described with reference to the accompanying drawings. For the purposes of clarity and simplicity, a detailed description of known functions and configuration incorporated herein will be omitted as it may make the subject matter of the present invention unclear.

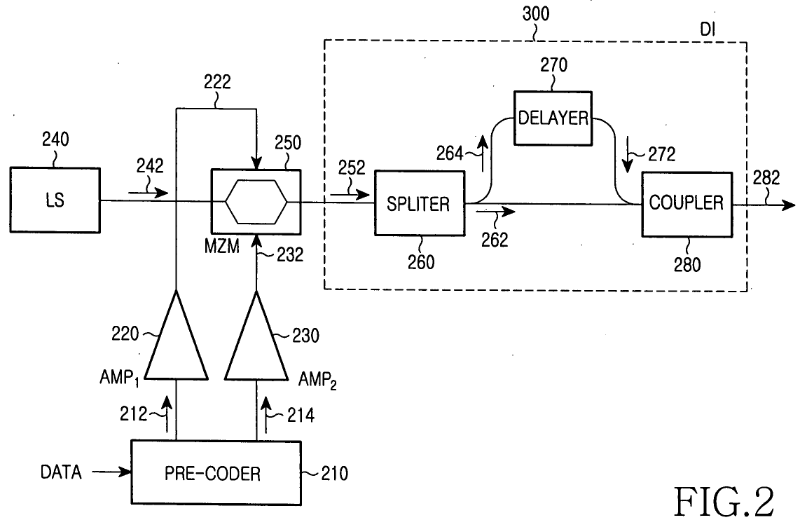

FIG. 2 is a block diagram showing a duo-binary optical transmitter according to an embodiment of the present invention. As shown, the inventive optical transmitter includes an LS 240, a pre-coder 210, a first and a second AMP 220 and 230, an MZM 250 and a DI 300.

The pre-coder 210 pre-codes input Non-Return-to-Zero (NRZ) binary data, divides the pre-coded signal (or 2-level signal) into a first branch signal and a second branch signal, inverts the second branch signal, and outputs the first branch signal (non-inverted signal) 212 and the second branch signal (inverted signal) 214. Further, the pre-coder 210 may include a 1-bit delay element, an exclusive-OR element, a branching means (e.g., parallel connection of conductive wires) for dividing outputs of the delay element and the exclusive-OR element into two branch signals, and an inverter for inverting one of the two branch signals.

The first AMP 220 is a modulator driver which amplifies and outputs the first signal 212 input from the pre-coder 210. The second AMP 230 is a modulator driver which amplifies and outputs the second signal 214 input from the pre-coder 210.

The LS 240 outputs a light 242 having a predetermined wavelength and may use a Continuous Wave (CW) laser, a DFB laser, etc.

The MZM 250 outputs a NRZ-DPSK modulated optical signal 252 obtained by modulating the light 242 input from the LS 240 according to the first amplified signal 222 and the second amplified signal 232. The MZM 250 includes a dual-arm, the first amplified signal 222 is applied to one of the dual-arm, and the second amplified signal 232 is applied to the other of the dual-arm. Furthermore, the MZM 250 may use a LiNbO₃ modulator including a dual-arm.

The DI 300 includes a splitter 260, a delay 270 and a coupler 280. The DI 300 splits the NRZ-DPSK modulated optical signal 252 into a first and a second split signal 262 and 264. Further, the DI 300 delays the second split signal 264 and outputs a duo-binary optical signal 282 obtained by interfering the first split signal 262 with the second delayed split signal 264.

The splitter 260 splits the NRZ-DPSK modulated optical signal 252 input from the MZM 250 into the first and the second split signal 262 and 264.

The delay 270 delays and outputs the second split signal 264 input from the splitter 260. Herein, it is preferred that the delay 270 has a delay time set to 0.5 to 0.8 bit.

The coupler 280 outputs the duo-binary optical signal 282 obtained by interfering the first split signal 262 input from the splitter 260 with a second delayed split signal 272 input from the delay 270.

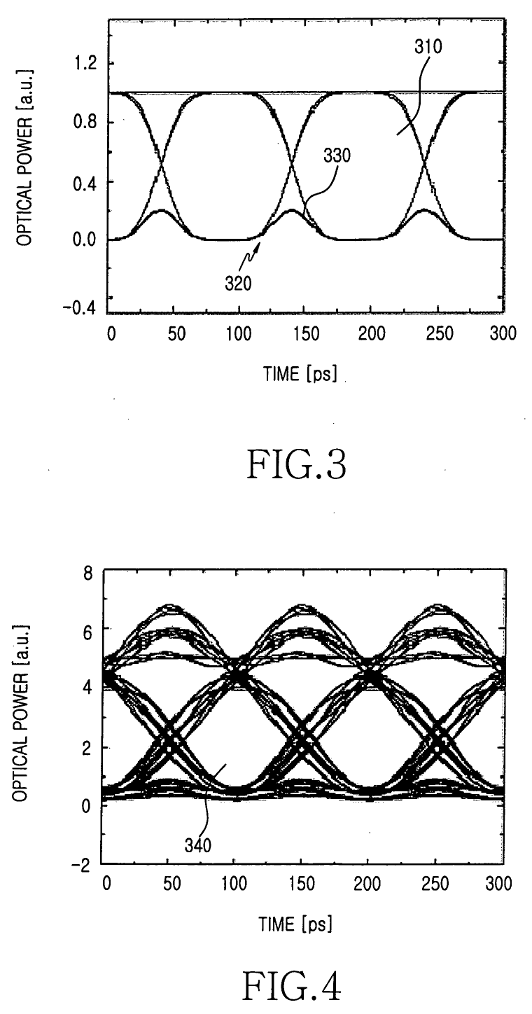

FIG. 3 is an eye diagram showing a back-to-back monitoring result for the duo-binary optical signal obtained by setting the delay time of the optical transmitter to 0.8 bit. As shown in FIG. 3, when the delay time of the delay 270 is set to 0.8 bit, one can see that the duo-binary optical signal has a wide window (or eye) 310 as a result of the back-to-back monitoring and has a periodic ripple 330 in a zero rail 320.

The improvement of dispersion characteristics of the duo-binary optical signal due to the periodic ripple 330 in the zero rail 320 may be evidence as follows.

FIG. 4 is an eye diagram showing a monitoring result for the duo-binary optical signal after the duo-binary optical signal obtained by setting the delay time of the optical transmitter to 0.8 bit has been transmitted for 160 km. As shown in FIG. 4, one can see that the duo-binary optical signal has a window 340 smaller than that of the case in the back-to-back monitoring of FIG. 3, but the window 340 is formed wider.

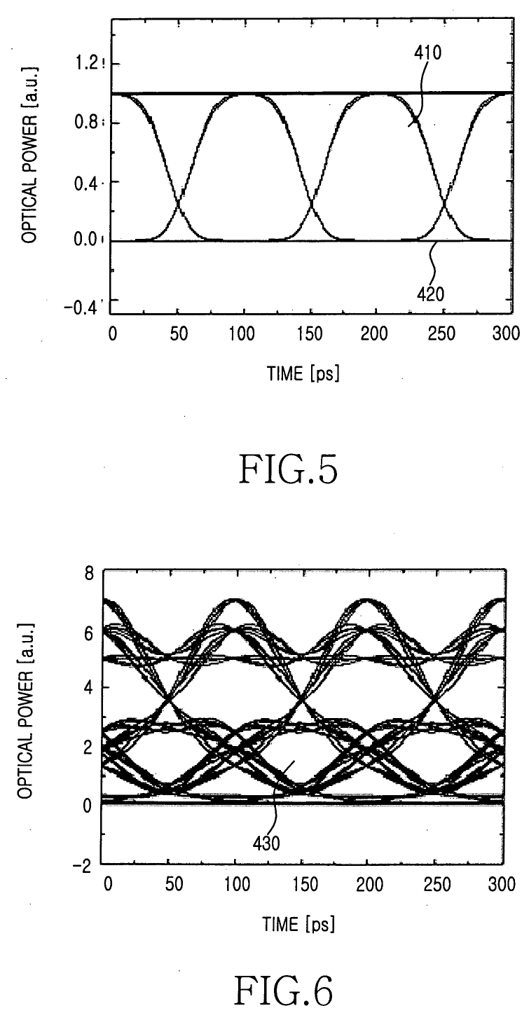

FIG. 5 is an eye diagram showing a back-to-back monitoring result for the duo-binary optical signal obtained by setting the delay time of the optical transmitter to 1 bit. As shown in FIG. 5, when the delay time of the delay 270 is set to 1 bit, one can see that the duo-binary optical signal has a wide window 410 as a result of the back-to-back monitoring and does not have a periodic ripple in a zero rail 420.

FIG. 6 is an eye diagram showing a monitoring result for the duo-binary optical signal after the duo-binary optical signal obtained by setting the delay time of the optical transmitter to 1 bit has been transmitted 160 km. As shown in FIG. 6, one can see that the duo-binary optical signal has a smaller window 430 and a greatly distorted waveform due to the chromatic dispersion of an optical fiber, as compared with the case in which the optical transmitter has the delay time set to 0.8 bit.

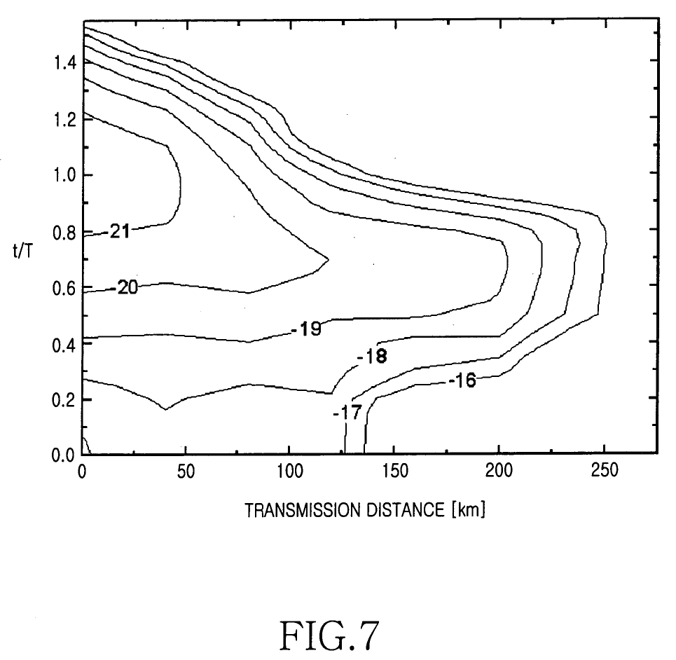

FIG. 7 is a graph illustrating the change of a receiver sensitivity according to the delay time of the optical transmitter. In FIG. 7, a transmission distance represents a distance in which the duo-binary optical signal output from the optical transmitter is propagated in a standard single mode fiber. Here, a ‘T’ represents a delay time constant corresponding to 1 bit and a ‘t’ represents a delay time variable. Equivalent lines having a value within a range of −21˜−16 dBm represent corresponding receiver sensitivities, respectively. When the transmission distance is 0 km, the most favorable receiver sensitivity is shown at a delay time of 1.0 T. When the transmission distance increases, the most favorable receiver sensitivity is shown at a delay time of 0.5˜0.8 T.

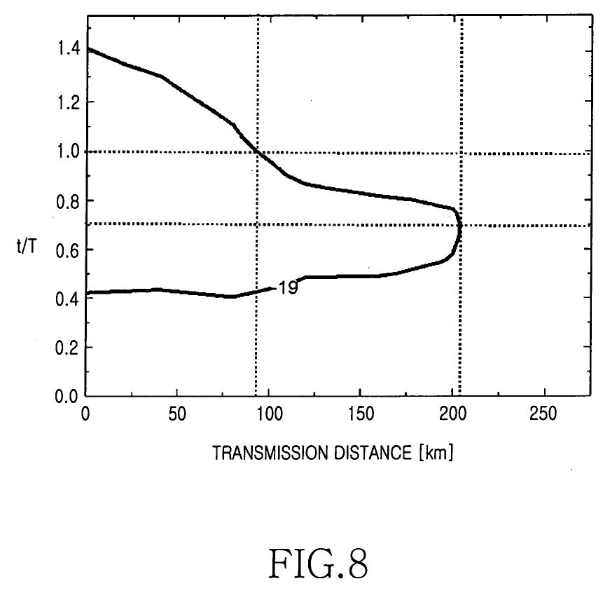

FIG. 8 is a graph showing a comparison of the optical transmitter having a delay time of 0.7 T versus a delay time of 1.0 T. As shown in FIG. 8, when the delay time of the delay 270 is set to 0.7 T, one can see that it is possible to more than doubling the transmission distance without compensating for the chromatic dispersion of an optical fiber, as compared with the case in which the delay time of the delay 270 is set to 1.0 T. That is, when the delay time is 1.0 T, it is possible to obtain a receiver sensitivity below −19 dBm up to about 100 km. However, when the delay time is 0.7 T, it is possible to obtain a receiver sensitivity below −19 dBm up to about 200 km.

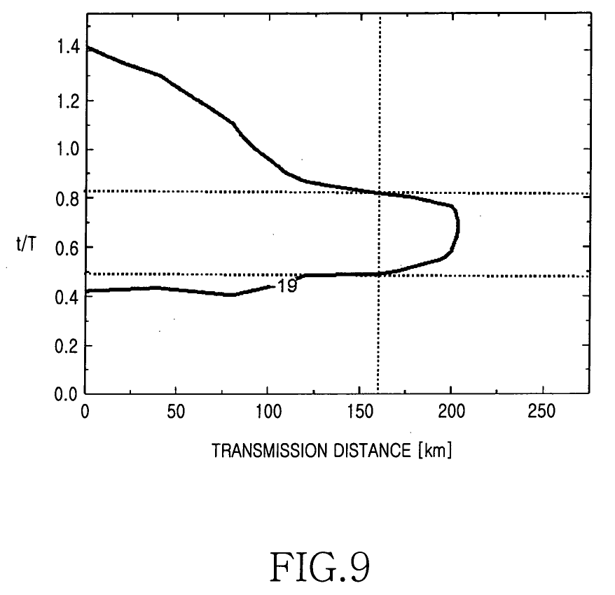

FIG. 9 is a graph showing an optimal delay time range of the optical transmitter. In a typical optical communication system, a span representing a distance between optical repeaters is generally set to 80 km in order to compensate for dispersion. As shown in FIG. 9, when the delay time of the optical transmitter is set to 0.5˜0.8 T, one can see that it is possible to transmit an optical signal up to two spans without the need of a dispersion compensation. That is, when the optical transmitter is applied to an existing optical communication system having a span of 80 km, it is possible to reduce the number of optical repeaters by one half.

As described above, a duo-binary optical transmitter according to the present invention does not use an LPF and sets a delay time of a DI to 0.5˜0.8 bit, so that the duo-binary optical transmitter is tolerant to the chromatic dispersion of an optical fiber. Therefore, it is possible to reduce a manufacturing cost of an optical communication system employing the optical transmitter.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A duo-binary optical transmitter tolerant to a chromatic dispersion, comprising:
a pre-coder for generating a first signal with 2-level from input binary data and for generating a second signal having a waveform obtained by inverting the first signal;
a Mach-Zehnder Modulator (MZM) for generating a Differential Phase Shift Keying (DPSK) modulated optical signal by modulating an input light according to the first signal and the second signal; and
a Delay Interferometer (DI) for splitting the DPSK modulated optical signal into a first split signal and a second split signal, delaying the second split signal, and generating a duo-binary optical signal by interfering the first split signal with the second delayed split signal,
wherein a time required for delaying the second split signal is set to 0.5˜0.8 bit.

2. The duo-binary optical transmitter as claimed in claim 1, wherein the binary data include non-return-to-zero (NRZ) binary data.

3. The duo-binary optical transmitter as claimed in claim 1, wherein the pre-coder pre-codes the input binary data into a 2-level signal, divides the pre-coded signal into a first branch signal and a second branch signal, inverts the second branch signal, and outputs the first branch signal as the first signal and the second inverted signal as the second signal.

4. The duo-binary optical transmitter as claimed in claim 1, further comprising:
a first amplifier for amplifying the first signal input from the pre-coder and for outputting the amplified signal to the MZM; and
a second amplifier for amplifying the second signal input from the pre-coder and for outputting the amplified signal to the MZM.

5. The duo-binary optical transmitter as claimed in claim 1, wherein the DI further comprises:
a splitter for splitting the DPSK modulated optical signal input from the MZM into the first split signal and the second split signal;
a delay for delaying and outputting the second split signal input from the splitter; and
a coupler for outputting a duo-binary optical signal obtained by interfering the first split signal input from the splitter with the second delayed split signal input from the delay.

6. The duo-binary optical transmitter as claimed in claim 1, further comprising a light source for generating the input light to the MZM.

7. The duo-binary optical transmitter as claimed in claim 6, wherein the light source is a Continuous Wave (CW) laser.

8. The duo-binary optical transmitter as claimed in claim 6, wherein the light source is a DFB laser.

9. The duo-binary optical transmitter as claimed in claim 1, wherein the MZM is a LiNbO₃ modulator having a dual-arm.

10. The duo-binary optical transmitter as claimed in claim 1, wherein the pre-coder comprises a 1-bit delay element, an exclusive-OR element, a branching means for dividing an output of the delay element and the exclusive-OR element into the first and second signals, and an inverter for inverting the first signal.
